(19) United States
(12) Patent Application Publication
(10) Pub. No.: US 2004/0256765 A1
(43) Pub. Date: Dec. 23, 2004

(54) Method and system for making a slip resistant mat

(75) Inventors: Ian S. Malpass, Alpharetta, GA (US); Jeffery L. Cofer, Conyers, GA (US)

Correspondence Address: KING & SPALDING LLP, 191 PEACHTREE STREET, N.E., ATLANTA, GA, 30303-1763, US

(73) Assignee: Millennium Mat Company, Suwanee, GA

(21) Appl. No.: 10/464,019

(22) Filed: Jun. 18, 2003

(51) Int. Cl. B29C 43/02

(52) U.S. Cl. 264/319; 425/406

(57) ABSTRACT

A system and method for making a slip resistant mat can include assembling parts with predetermined geometries to form a mold system that can be used for making slip resistant mats that have suction cups. The unique geometries of the parts which form the mold system can be manufactured efficiently and with reduced costs. The mold system of the present invention can be used to make slip resistant mats with suction cups and an angled edge that can support heavy mechanical loads and heavy foot traffic without moving from a desired locations where the mats are initially positioned.

### FIELD OF THE INVENTION

This invention relates generally to slip resistant, anti-skid or anti-creep mats. Specifically, the present invention relates to a method in system for making slip resistant mats.

### BACKGROUND OF THE INVENTION

In the past, rubber floor mats have been made with either a smooth back, primarily for solid or non-carpeted floors, or with a variety of grippers or cleats arranged to reduce the movement on carpeted floors. However, both of these approaches resulted in floor mats that were not skid resistant, especially those floors with high traffic areas or loads being moved over them. With high traffic or loads, these conventional mats could be moved. The movement of a mat can be caused by foot or vehicle traffic that can compress and expand areas of the mat.

One approach in the conventional art to prevents mat from moving because of foot or vehicle traffic is fabricating mats with suction cups such that the suction cups adhere to a smooth surface beneath the mat. Once conventional mat design with suction cups can be found on shower and bath mats. While such mats can provide acceptable slip-resistance for bathing and home-use applications, conventional suction cups on mats are usually not sufficient to provide adequate anti-skidding forces to prevent slipping and movement of a mat in high traffic or high load areas (or both).

To overcome the problems associated with traditional suction cups, conventional slip resistant mat designs include suction cups that are positioned within support rings that also part of a slip resistant mat. A depth of the support rings and suction cups is such that the bottom edges of the suction cups can extend perpendicularly from the mat farther than the bottom edges of the support rings when the mat is not loaded. Upon being placed on a surface, such as a smooth floor, the suction cups can adhere to the floor. When loaded, the suction cups will be compressed such that they fall within the support rings, and the support rings will provide upward forces against any loads traversing the mats.

While this conventional mat design comprising the suction cups and support rings does provide some slip resistance, in come cases when narrow loads such as wheels of heavy-loaded carts traverse the edges of such mats can sometimes move. This movement is caused by the suction cups being released since the edge of the mats can be lifted by the wheels of the carts.

In addition to the problem of slip resistant mats moving when traversed by heavy loads, another drawback of slip resistant mats relates to the manufacturing process of these mats. Mats with suction cups usually require raw materials with an increased thickness to ensure proper formation of the suction cups. Mats with increased thickness can add to the weight of a mat. Heavy mats are undesirable because cleaning of the mats is usually based on weight. Conventional manufacturing techniques have not addressed these problems often associated with conventional slip resistant mats.

Another problem with manufacturing slip resistant mats and mats in general relates to the amount of pressure needed to form the mats. Conventional techniques require high pressure to be applied to the rubber that fills the molds for mats. Some conventional techniques require magnitudes such as on the order of 400 to 600 psi (pounds per square inch).

Accordingly, there is a need in the art for a method and system for making slip resistant mats that can withstand heavy mechanical loads and do not move when traversed by such loads. Another need exists in the art for a system and method for making a slip resistant mat in an efficient manner. Specifically, need exists in the art for a system and method for making a slip resistant mat that is lightweight and can be made with a reduced amount of materials compared to conventional manufacturing techniques. Another need exists in the art for making slip resistant mats in a low pressure environment.

### SUMMARY OF THE INVENTION

The present invention is generally drawn to a system and method for making a slip resistant mat. More particularly, the system and method can include assembling parts with predetermined geometries to form a mold system that can be used for making slip resistant maps that have suction cups. Each part of the mold system can have predetermined geometrical shapes that can be manufactured efficiently and with reduced cost.

One part of the mold system can include a dimple plate. The dimple plate can comprise a metal sheet that has a plurality of projections or convex surfaces that project above a planar surface of the metal sheet to form “dimples”. The projections can be shaped to provide the base structure that can form an interior region of a suction cup. The projections can be formed by a punching process that employs a computer numerical controlled (CNC) machine. By using a CNC machine for punching the metal sheet, the dimple plate can be made very efficiently and with reduced cost compared to conventional machining methods. The projections can have a predetermined geometry such that they can mate with another part of the mold system.

The part of the mold system which can mate with the projections of the dimple plate can include cup shaping inserts. Each cup shaping insert can comprise a predetermined geometry that can form the exterior region of a suction cup. An insert can include an aperture on a first side and a second side comprising a cup shaped recess that is aligned and connected to the aperture. The first side with the aperture can have a predetermined geometry surrounding the aperture that can mate with a predetermined geometry of a carrier plate. The second side comprising the cup shaped recess can be designed to correspond with the shape of the projections of the dimple plate such that the cup shaped recess can securely mate with a respective projection on the dimple plate.

The carrier plate can comprise a plurality of apertures that receive the first side of the cup shaping inserts. The apertures of the carrier plate can be aligned with the apertures of the cup shaping inserts when the inserts mate with the carrier plate. The apertures can correspond to the projections of the dimple plate. That is, each aperture of the carrier plate can correspond with a respective projection of the dimple plate. The carrier plate can also have dimensions that correspond to the dimensions of the dimple plate. The dimensions of the carrier plate and dimple plate can generally correspond with those of the finished product comprising a slip resistant mat.

The raw material used to form the slip resistant mat can comprise rubber. According to one exemplary embodiment when the mold system of the present invention is used in a two side-heated press, the rubber is extruded to have a predefined geometry. This predefined geometry includes excess thickened regions of rubber that are positioned to correspond with the apertures in the carrier sheet and the apertures in the cup shaping inserts. Using extruded rubber with this predefined geometry can permit fabricating the mats with less rubber material compared to conventional methods since the excess rubber material needed to flow into the cup shaping inserts is placed adjacent to the apertures of the cup shaping inserts. However, when using the mold system of the present invention with conventional single-sided presses, rubber with the predefined geometry may not be needed. Conventional mat fabrication methods typically require thick mats having a uniform cross section in order to fill the cup shaping inserts. Fabricating mats with less rubber material by using the rubber with the predefined geometry can reduce the weight of the finished mat. Light weight mats are desirable since they can decrease cleaning costs as costs for cleaning mats is usually based on weight.

To enhance the flow of the mat material across the surface of the mold system, a sheet of teflon (polytetrafluoroethylene coating) can be applied to the mold system. Other material flow enhancing sheets or coatings are not beyond the scope of the present invention. Prior to applying the material flow enhancing sheet to the mold system, apertures can be made within the sheet to correspond with the apertures of the carrier sheet and the apertures of the cup shaping inserts.

The carrier plate, cup shaping inserts, and dimple plate can be positioned within a frame to form the mold system for the slip resistant mat. The frame can comprise a surface with a predetermined angle that forms an angled edge surface of the finished mat. The predetermined angle of the frame can comprise a magnitude that prevents separation of a finished mat edge from a surface when traversed by heavy loads, such as wheeled carts. The predetermined angle invention can be calculated from field experiments.

The mold system of the present invention can be used in a press that includes the application of pressure and heat to two sides of the mold system. With the application of heat and pressure to two sides of the mold system, the amount of pressure needed to make the slip resistant mats can be substantially reduced compared to conventional techniques. According to one exemplary embodiment, the mold system can form mats under a pressure range of between 50 and 70 psi. However other pressure ranges are not beyond the scope and spirit of the present invention.

While the aforementioned mold system has presses that can apply heat and pressure to two sides, according to another alternate and exemplary embodiment, the mold system can be used with conventional presses where pressure is usually applied to one side of the mold system and with fluidic pressure device such as a conventional balloon-like structure. When used in conventional presses, the frame can be removed from the mold system as the predetermined angled edge surface of the mat can be formed with adjusting pressure of the conventional balloon-like structure.

The method for making a slip resistant mat can include assembling the parts of the mold system having the inventive geometries discussed above in a predetermined order and moving the mat material into the geometries by using heat and pressure. Specifically, the method for making a slip resistant mat according to one exemplary embodiment of the present invention can include aligning apertures and cup-shaped recesses supported by a carrier plate with projections on a dimple plate and placing the carrier plate adjacent to the dimple sheet to form a mold system. Next, the method can include positioning raw material on the mold system and moving the raw material into geometries of the mold system to form the mat.

### BRIEF DESCRIPTION OF THE DRAWINGS

FIG. 1 is an isometric view of a partially assembled mold system having a frame portion and without a material flow enhancing sheet according to one exemplary embodiment of the present invention.

FIG. 2A is an isometric assembly view of the various parts of a mold system that includes a material enhancing sheet and an extruded raw material sheet with a predetermined geometry according to one exemplary embodiment of the present invention.

FIG. 2B is a side view of the various parts of the mold system illustrated in FIG. 2A according to one exemplary embodiment of the present invention.

FIG. 3 illustrates an isometric view of a dimple sheet that forms part of the mold system according to one exemplary embodiment of the present invention.

FIG. 4 illustrates a cross-sectional view of one of the projections of the dimple sheet illustrated in FIG. 3.

FIG. 5 is a side view of a cup shaping insert according to one exemplary embodiment of the present invention.

FIG. 6 illustrates a cross sectional view of the cup shaping insert illustrated in FIG. 5.

FIG. 7 illustrates cup shaping inserts positioned in apertures of a carrier plate as well as apertures without inserts such that some projections of a dimple plate are revealed according to one exemplary embodiment of the present invention.

FIG. 8 illustrates a cross sectional view of a cup shaping insert mating with a projection of the dimple plate illustrated in FIG. 7.

FIG. 9 illustrates a cross sectional view of a frame with a predetermined angle according to one exemplary embodiment of the present invention.

FIG. 10 is a perspective view of a frame according to one exemplary embodiment of the present invention.

FIG. 11 is functional block diagram of how heat and pressure are applied to the mat material and mold system according to one exemplary embodiment of the present invention.

FIG. 12 is a cross sectional view of exemplary finished mat product having a predetermined angled edge according to one exemplary embodiment of the present invention.

FIG. 13 illustrates a flow chart of steps of a method for making a slip resistant mat according to one exemplary embodiment of the present invention.

FIG. 14 illustrates a flow chart of steps of an exemplary submethod for forming a dimple plate according to one exemplary embodiment of the present invention.

FIG. 15 illustrates a flow chart of steps of an exemplary submethod for forming an insert carrier plate according to one exemplary embodiment of the present invention.

FIG. 16 illustrates a flow chart of steps of an exemplary submethod for fabricating cup shaping inserts according to one exemplary embodiment of the present invention.

FIG. 17 illustrates a flow chart of steps of an exemplary submethod for forming a frame according to one exemplary embodiment of the present invention.

FIG. 18 illustrates a flow chart of steps of an exemplary submethod for preparing a material flow enhancing sheet according to one exemplary embodiment of the present invention.

FIG. 19 illustrates a flow chart of steps of an exemplary submethod for assembling parts to form a mold system according to one exemplary embodiment of the present invention.

FIG. 20 illustrates a flow chart of steps of an exemplary submethod for forming a raw material with a predefined geometry according to one exemplary embodiment of the present invention.

FIG. 21 illustrates a flow chart of steps of an exemplary submethod for moving the raw material into geometries of the mold system according to one exemplary embodiment of the present invention.

### DETAILED DESCRIPTION OF EXEMPLARY EMBODIMENTS

A system and method for making a slip resistant mat can include assembling parts with predetermined geometries to form a mold system that can be used for making slip resistant mats that have suction cups. The unique geometries of the parts which form the mold system can be manufactured efficiently and with reduced costs. The mold system of the present invention can be used to make slip resistant mats with suction cups that can support heavy mechanical loads and heavy foot traffic without moving from a desired locations where the mats are positioned.

Exemplary embodiments of the present invention will hereinafter be described with reference to the drawings, and which like numerals represent like elements throughout the several figures.

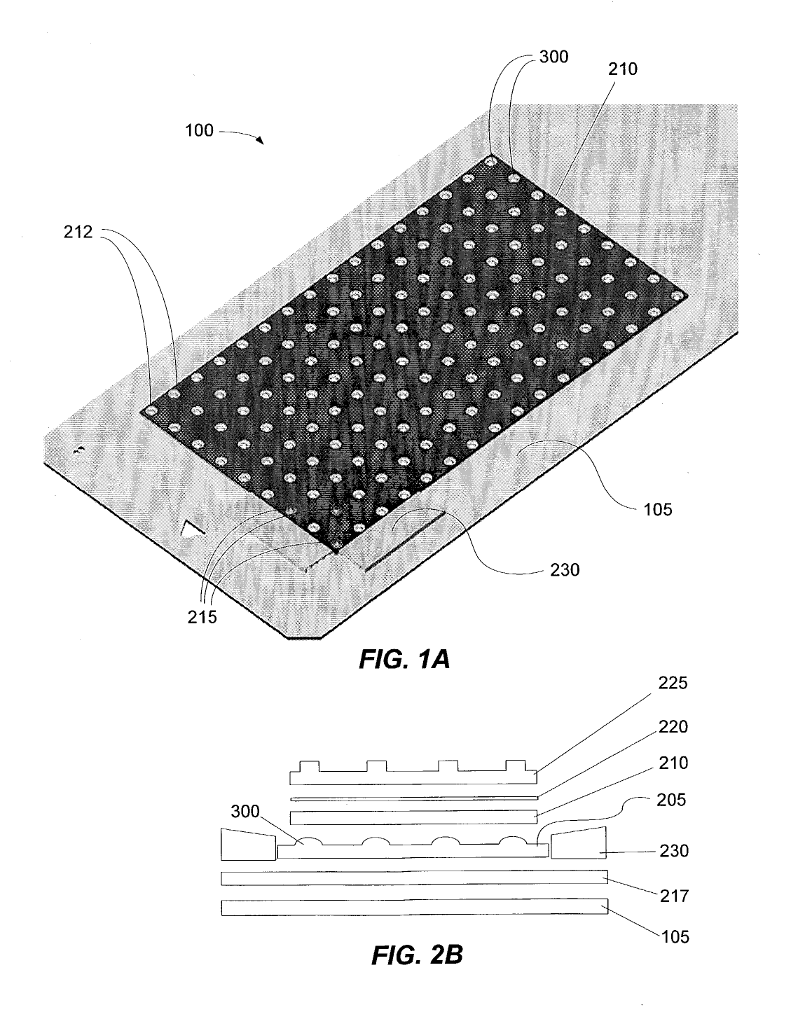

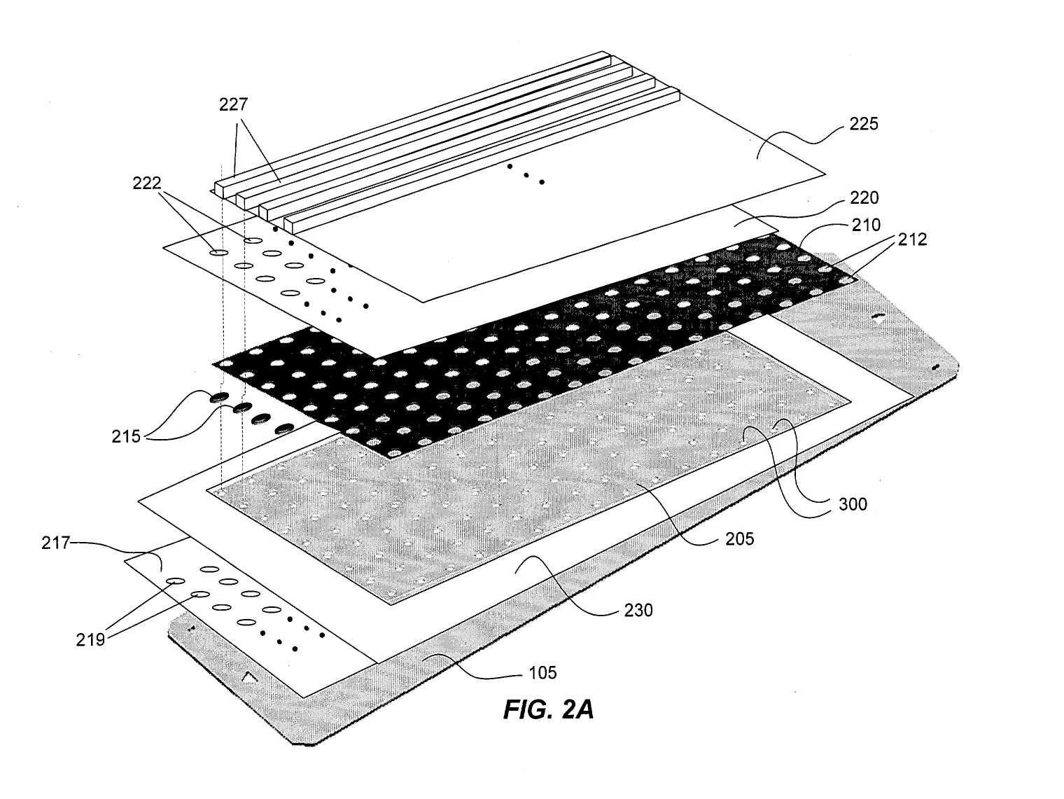

Referring now to FIG. 1, this figure illustrates an isometric view of a partially assembled mold system 100 (depicted without a material flow enhancing sheet) according to one exemplary embodiment of the present invention. The partially assembled mold system 100 can comprise a carrier plate 210, sections of a frame 230, and the base plate 105. Further details of the frame 230 will be discussed below with respect to FIGS. 2, 9 and 10. The carrier plate 210 can comprise a plurality of apertures 212. The apertures 212 are typically aligned with projections 300 of a dimple plate 205 positioned adjacent to the carrier plate 210. The apertures 212 can secure inserts 215 that will be shown and discussed in further detail below. The projections 300 and inserts 215 can form the shape for suction cups of a slip resistant mat that can be formed with the mold system 100 of the present invention.

Referring now to FIG. 2A, this figure illustrates an isometric assembly view of various parts of the mold system 100 that includes a material flow enhancing sheet 220 and an extruded raw material sheet 225 having a predetermined geometry according to one exemplary embodiment of the present invention. The predetermined geometry can include thickened regions 227 that will be discussed in further detail below.

As illustrated in FIG. 2A, the base plate 105 can support a spacer plate 217. The spacer plate 217 can provide support for the frame 230 (shown in schematic form in this figure) and the dimple plate 205. The spacer plate 217 can comprise apertures 219. These apertures 219 are sized to be slightly larger than the diameter of a protrusion 433 (See FIG. 4) on the underside of the dimple plate 205. The pattern of the apertures 219 is typically the same as dimple plate 205 and carrier plate 210. The spacer plate 217 can function as a washer and can comprise a thickness of 0.04 of an inch.

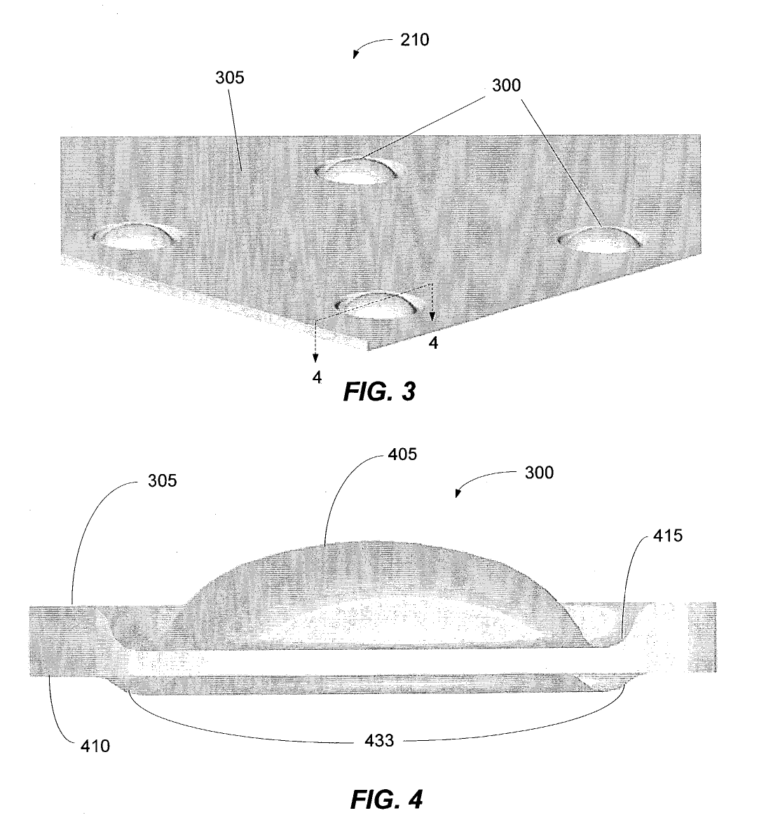

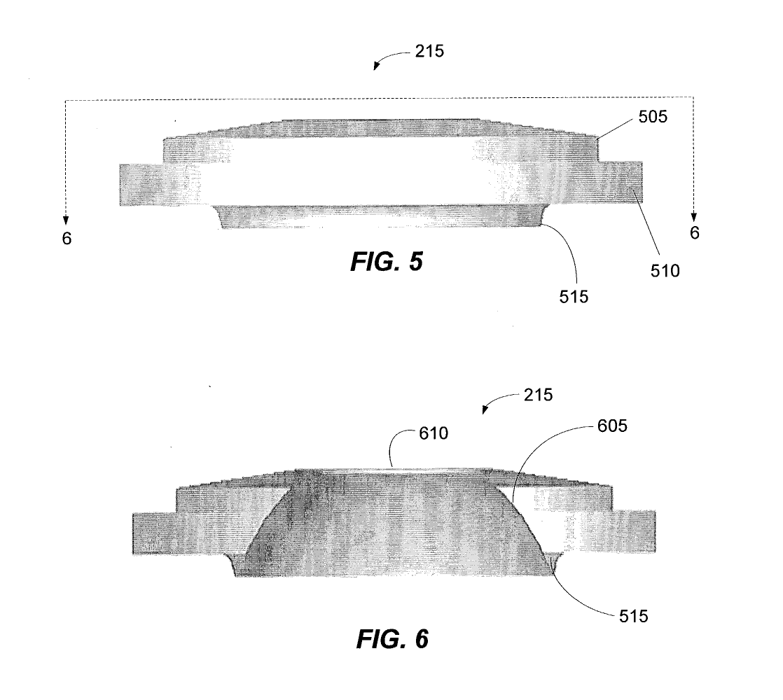

The dimple plate 205 that comprises the projections 300 that are aligned with the apertures 212 of the carrier plate 210. The specific geometry of the projections 300 are show in further detail and discussed below with respect to FIGS. 3 and 4. Similarly, further details of the inserts 215 are discussed below with respect to FIGS. 5 and 6. The inserts 215 have a predefined geometry such that they mate with only one side of respective apertures 212 of the carrier plate 210.

The carrier plate 210 supports a material flow enhancing sheet 220 that can also comprise apertures 222 that correspond with the apertures 212 of the carrier plate 210. The material flow enhancing sheet 220 can then support the raw material 225 that has a predetermined geometry for facilitating formation of suction cups.

Referring now to FIG. 2B, this figure illustrates an exemplary side view of the stacked elements of the mold system according to one exemplary embodiment of the present invention. From this Figure, it can be seen how the projections 300 are designed to line up with the thickened regions 227. Although not shown in FIG. 2B, the apertures 212, 222, and 229 of the carrier plate 210, material flow enhancing sheet 210, and spacer plate 217 can also be aligned with the projections 300 and thickened regions 227. The thicknesses of the materials shown in each of the Figures are for illustrative purposes. The actual relative thicknesses of the materials that can be used to form the claimed invention can vary if the exact dimensions of materials have not been described in the application.

Exemplary Materials

The base plate 205 can be made from metal materials such aluminum. Specifically, according to one exemplary embodiment, the base plate 105 can comprise 5052 aluminum. However, other types of metals are not beyond the scope and spirit of the present invention.

The frame 230 can also comprise metal materials such as aluminum. Specifically, the frame 230 can comprise extruded 6061 aluminum. However, other types of metals for the frame 230 are not beyond the scope and spirit of the present invention.

The dimple plate 205 can also comprise metal materials such as aluminum. Specifically, the dimple plate 205 can comprise 5052 aluminum. However, other metal materials for the dimple plate 205 are not beyond the scope and spirit of the present invention.

The inserts 215 can be made from metal materials such as aluminum. Specifically, the inserts 215 can comprise steel. However, other metal materials for the inserts 215 are not beyond the scope and spirit of the present invention.

The carrier plate 210 can also comprise metal materials. Specifically, the carrier plate 210 can be made from 5052 aluminum. However, other metal materials for the carrier plate 210 are not beyond the scope and spirit of the present invention.

The material flow enhancing sheet 220 can comprise a material that helps the raw material used to form mats to move across its surface during the manufacturing process. The material flow enhancing sheet 220 can comprise TEFLON (polytetrafluoroethylene coating). However, other materials that enhance raw material flow during a molding process are not beyond the scope and spirit of the present invention.

The raw material 225 can comprise extruded rubber having a predetermined shape. In one exemplary embodiment, the rubber can have a durometer of about sixty. However, other raw materials 225 are not beyond the scope and spirit of the present inventions. Other raw materials 225 can include, but are not limited, thermoplastics, elastomers, thermosettings polymers, composite materials, ceramic materials, and mixtures of any of these materials.

The raw material sheet 225 can further comprise thickened regions 227 that are designed to correspond with the rows of apertures 222 on the material flow enhancing sheet 220 and the rows of apertures 212 on the carrier plate 210. The thickened regions 227 can be made with an extruder (not shown) having a cross-sectional pattern that can form the thickened regions 227. While the thickened regions 227 have been illustrated as elongated rectangular prismatic members, other shapes of the thickened regions 227 are not beyond the scope and spirit of the present invention.

The thickened regions 227 can provide the requisite material needed to form the suction cups of a finished slip resistant mat (not shown in FIG. 2). By using raw material 225 having the thickened regions 227, slip resistant mats can be made with less rubber material compared to conventional methods since the excess rubber material needed to flow into the cup-shaping inserts 215 can be placed adjacent to the apertures of the cup-shaping inserts 215. When using the mold 105 of the present invention with conventional single-sided presses, raw material 225 having the projections 227 may not be needed However, a uniformly thick raw material 225 may be required to form the suction cups when used with a conventional single-sided press, otherwise the resulting mat will have a large gauge variation.

Fabricating mats with reduced amounts of rubber material by using the raw material 225 with the predefined geometry can reduce the weight of a finished mat (not shown in FIG. 2). Lightweight mats are desirable since they can decrease cleaning costs as costs for cleaning mats is usually based on weight.

Exemplary Parts of the Mold System 100

Referring now to FIG. 3, this figure illustrates an isometric view of the dimple plate 210 that forms part of the mold system 100 according to one exemplary embodiment of the present invention. The dimple plate 210 can comprise projections 300 which extend above planar regions 305 of the dimple sheet 210. The projections 300 are designed to correspond with the shape of the inserts 215 and to align with the apertures 212 of the carrier plate 210. Further details of the projections 300 will be discussed below with respect to FIG. 4.

Referring now to FIG. 4, this figure illustrates a cross-sectional view of one of the projections 300 of the dimple plate 210 taken along the cut line 4-4 of FIG. 3. Each projection 300 comprises a convex shaped surface 405 that corresponds to an interior portion of a suction cup. In other words, the convex shaped surface 405 can be used to form the interior region of a suction cup of a slip resistant mat that can be formed with the mold system 100 of the present invention.

The projections 300 can be formed by a punching process that employs a computer numerical controlled (CNC) machine. By using a CNC machine for punching the metal sheet 210 on a side 410 opposite to the cup shaped surface 405, the dimple plate 210 can be made very efficiently and with reduced cost compared to conventional machining methods. The projections 300 have a predetermined geometry that is designed to mate with the inserts 215 as will be discussed below. Adjacent to each projection 300 is a groove 415 that is designed to receive the bottom portion of the inserts 215.

On the side 410 opposite to the convex shaped surface 405 is a protrusion 433. The protrusion 433 circumscribes an outer portion of the concave side of the convex shaped surface 405. This protrusion 433 can mate with apertures 219 of the spacer plate 217 as discussed above.

Referring now to FIG. 5, this figure illustrates a side view of a cup-shaping insert 215 according to one exemplary embodiment of the present invention. The cup-shaping insert 215 generally comprises a circular shape that is designed to mate with the carrier plate 210 and the dimple plate 205. Specifically, the cup-shaping insert 215 can comprise a first mating section 505 that is designed to be received by an aperture 212 of the carrier plate 210. The cup-shaping insert 215 can further comprise a rim section 510 that is also received by the aperture 212 of the carrier plate 210.

The cup-shaping insert 215 further comprises a second mating section 515 that couples with the groove 415 of the cup-shaped projection 405 of the dimple plate 300. As illustrated in FIG. 5, the first mating section 505 has a diameter greater than a diameter of the second mating section 515. However, it is possible to make a cup-shaping insert 215 where the second mating section 515 has a diameter greater than a diameter of the first mating section 505.

Referring now to FIG. 6, this figure illustrates a cross-sectional view of the cup-shaping insert 215 taken along the cut line 6-6 of FIG. 5. The cup-shaping insert can comprise a concave-shaped recess 605 that is designed to receive the cup-shaped surface 405 of the projection 300 of dimple plate 205. The cup-shaped recess 605 penetrates through the second mating section 515, the rim section 510, and the first mating section 505. The concave-shaped recess 605 becomes part of an aperture 610 that is designed to correspond with a respective aperture 212 in the carrier plate 210. Each cup-shaping insert 215 can comprise this predetermined geometry 605 that can form the exterior region of a suction cup of a slip resistant mat. The geometry of the concave-shaped recess 605 can be varied or adjusted as needed in order to change the shape of the suction cup that can be formed with this geometry.

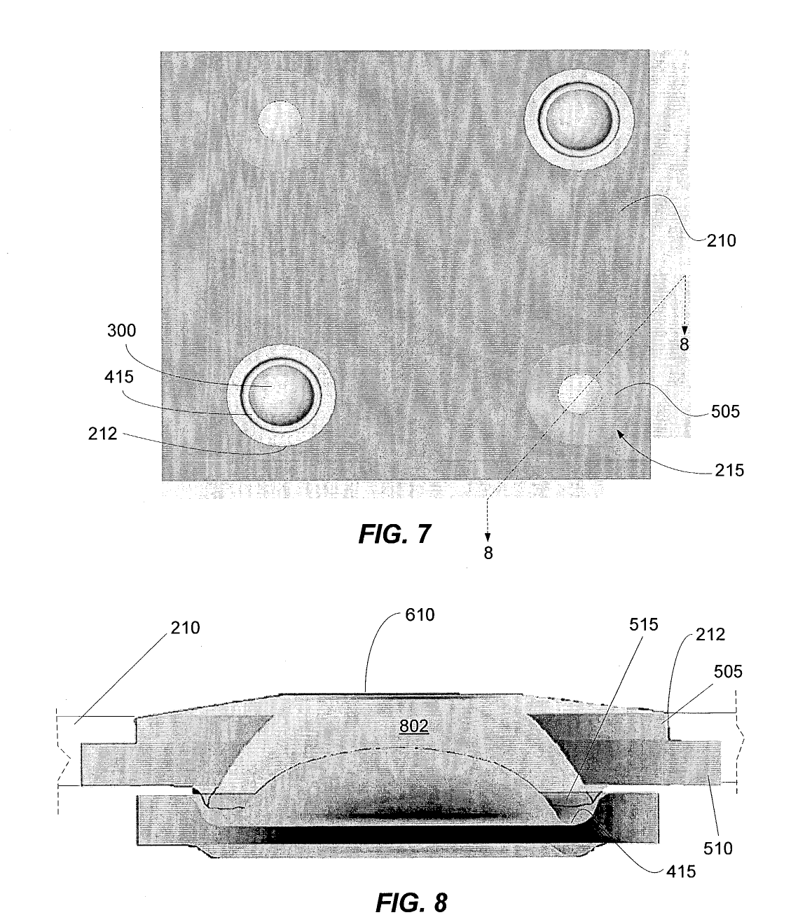

Referring now to FIG. 7, this figure illustrates cup-shaping inserts 215 positioned in apertures 212 of a carrier plate 210 as well as apertures 212 not having any inserts 215 such that more details of projections 300 are revealed according to one exemplary embodiment of the present invention. As mentioned above, the apertures 212 are preferably aligned with the projections 300 of the dimple plate 205. Similarly, the cup-shaping inserts 212 comprising their own aperture 610 are designed to align with the apertures 212 of the carrier plate 210.

Referring now to FIG. 8, this figure illustrates a cross-sectional view of a cup-shaping insert 215 mating with a projection 300 of the dimple plate 205 taken along the cut line 8-8 of FIG. 7. As illustrated in FIG. 8, the aperture 212 of the carrier plate 210 can receive the first mating section 505 and the rim section 510 of the cup-shaping insert 215.

The second mating section 515 of the cup-shaping insert 215 can be accurately positioned within the groove 415 that is adjacent to the concave-shaped surface 405 of the projection 300 of the dimple plate 310. While the dimple plate and its projections 300 are made from a CNC punch process and the cup-shaping inserts 215 are made from machining processes, both assemblies are made with such precision that the cup-shaping insert 215 fits snugly (with little or no slack) within the groove 415. This snug or tight fit does not permit the raw material 225 flow outside of the second mating section 515/groove 415 junction when the raw material 225 is in a fluidic state.

In other words, the raw material 225 used to make a suction cup will not flow outside of the groove 415 or second mating section 515 when flowing through the aperture 610 of the cup-shaping insert 215.

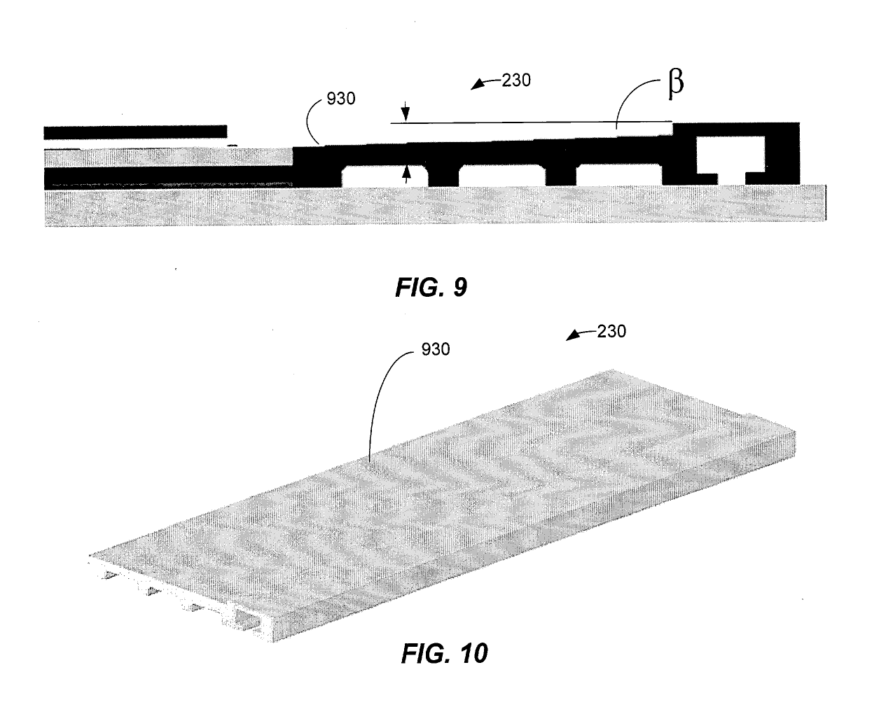

Referring now to FIG. 9, this figure illustrates an exemplary cross-sectional view of the frame 230 that surrounds the various sheets that form the mold system 100 of the present invention. The frame 230 can comprise a metal that is extruded with a predetermined geometry. This predetermined geometry can comprise an angle beta (β) that is used to form the exterior regions of a slip resistant map.

Specifically, the frame 230 can comprise a raw material receiving surface 905 that has the predetermined angle beta (β) in order to form an angled edge surface of the finished mat (not shown). The predetermined angle beta (β) of the frame 230 can comprise a magnitude that prevents separation of a finished mat edge from a smooth surface when the finished mat is traversed by heavy loads, such as wheeled carts. The predetermined angle of the present invention can be calculated from field experiments. In one exemplary embodiment, the angle beta (β) can comprise a magnitude of 1.15 degrees.

Referring now to FIG. 10, this figure illustrates a perspective view of a frame 230 according to one exemplary embodiment of the present invention. As noted above, the frame 230 can be made from an extruded metal material where the extruder (not shown) has a cross sectional geometry that can form the predetermined angle beta (β) of the present invention.

Refer now to FIG. 11, this figure is a functional block diagram of how heat and pressure are applied to the raw material 225 and mold system 100 according to one exemplary embodiment of the present invention. Unlike conventional presses which typically apply pressure to only side of a mold, the present invention can employ a press that uses platens 1100, 1105 that apply heat and pressure to both sides of the mold system 100 and raw material 225.

Using a two-sided press that applies heat to both sides of the mold 100 and raw material 225 can reduce an amount of rubber material used to fabricate slip resistant mats. Specifically, by using a two-sided press that applies heat to both sides of the raw material 225, raw material 225 with a unique geometry can be used. This unique geometry can comprise projections 227 which are excess material positioned in the areas needed to form the suction cups. Further, the two-sided press can also reduce the amount of pressure needed to form the slip resistant mats. For example, the two-sided press can apply pressure between the 50 and 70 psi to yield good quality slip resistant mats. Other pressures above or below the range discussed above are not beyond the scope and spirit of the present invention.

While FIG. 11 illustrates an exemplary embodiment of the present invention, those skilled in the art will recognize that the mold system 100 of the present invention can be used in conventional presses where pressure is usually applied to one side of the mold and with a fluidic pressure device such as a conventional balloon-like structure. Also, as noted above, when the mold system 100 is used in conventional presses, the frame 230 can be removed from the mold as the predetermined angled edge surface of the mat can be formed with adjusting pressure of the conventional balloon-like structure. Further, with conventional presses, the unique geometry of the raw material 225 may not be needed.

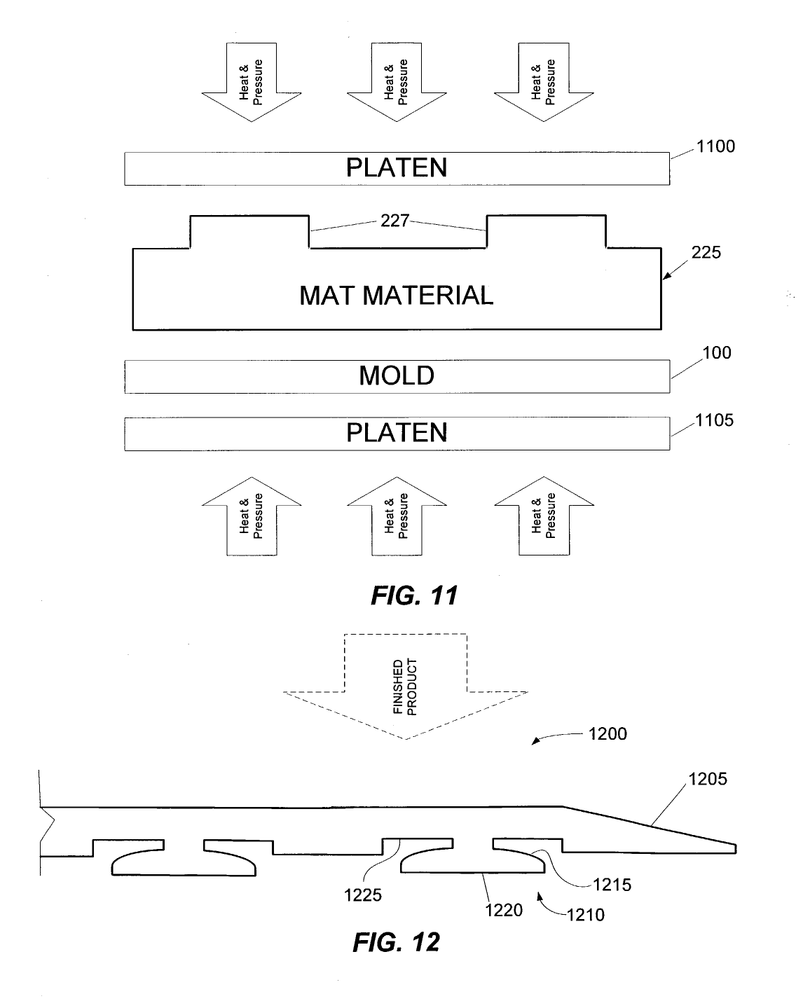

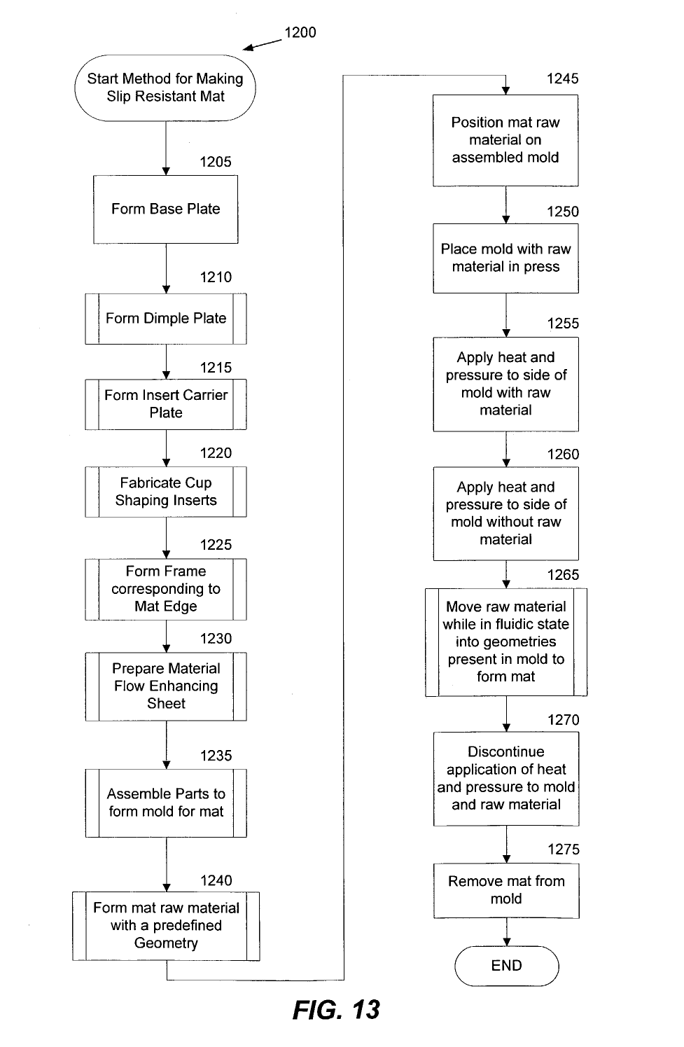

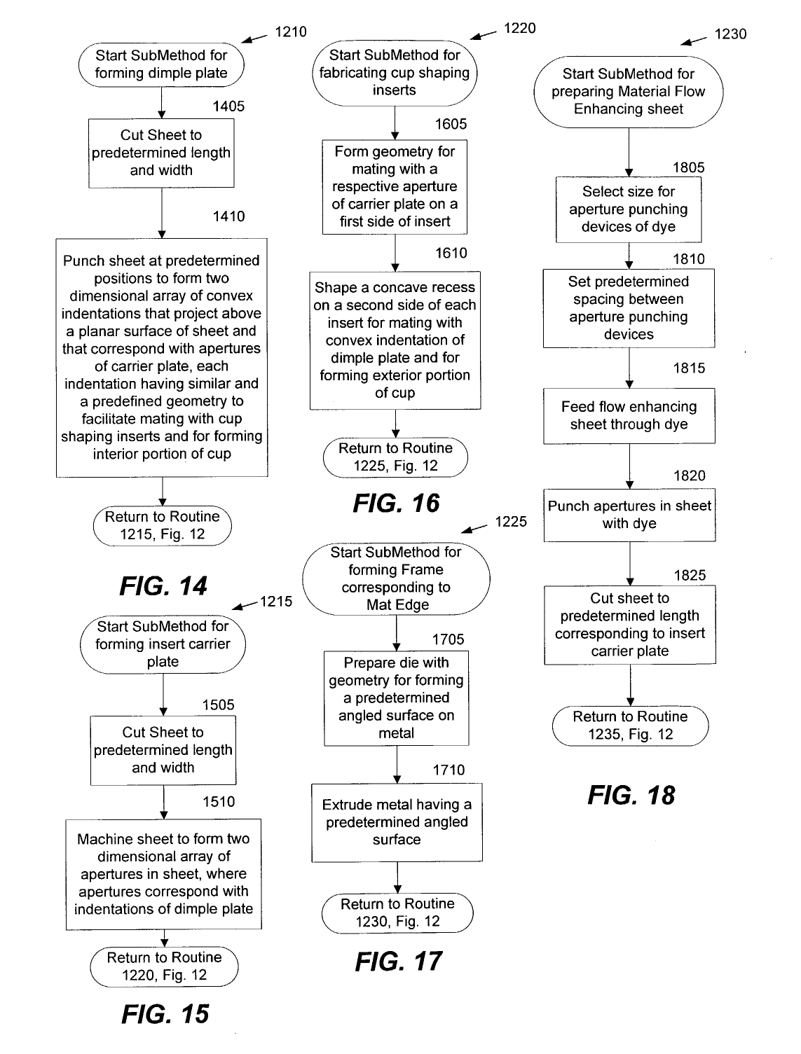

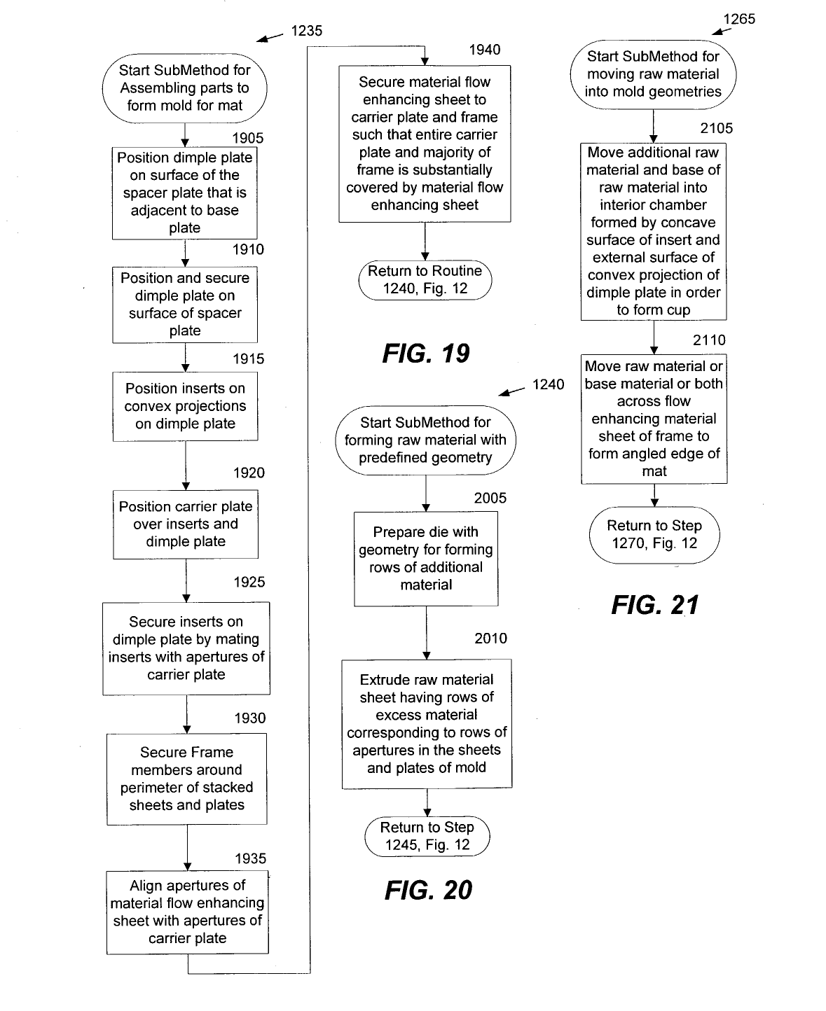

Referring now to FIG. 12, this figure is a cross sectional view of an exemplary finished mat 1200 having a predetermined angled edge 1205 according to one exemplary embodiment of the present invention. The finished mat 1200 can comprise suction cups 1210 that include exterior regions 1215 and interior regions 1220. The interior regions 1220 of the suction cups 1210 are formed by the convex-shaped surfaces 405 of the projections 300 disposed on the dimple plate 205.

Meanwhile, the exterior regions 1215 of the suction cups 1210 are formed by the concave-shaped recesses 605 of the cup-shaping inserts 215. The finished mat 1200 can further comprise ring regions 1225. The ring regions 1225 may comprise circular grooves formed around the suction cups 1210 that are designed to receive the suction cups 1210 when they are depressed.

The angled edge 1205 of the finished mat 1200 is designed to remain stationary when traversed by focused heavy loads such as wheels of a cart. The angled edge 1205 does not lift up or follow the movement of a wheel unlike the conventional slip resistant mats that do not have an angled surface 1205.

Referring now to FIG. 13, this figure illustrates a flow chart of steps for a method of making a slip resistant mat according to one exemplary embodiment of the present invention. It is noted that certain steps in the processes described below must naturally precede others for the present invention to function as described. However, the present invention is not limited to the order of the steps described if such order or sequence does not alter the functionality of the present invention. That is, is recognized that some steps may be performed before or after other steps or in parallel with other steps without departing from the scope and spirit of the present invention.

Step 1305 is the first step in the process 1300 for making a slip resistant mat 1200. In step 1305, a base plate 105 can be formed. The base plate 105 can be machined and cut to predetermined size and shape that corresponds with the shape of a desired slip resistant mat. The base plate 105 is typically sized to support the frame 230 as well as the other parts of the mold system 100.

Next, in routine 1310, the dimple plate 210 can be formed from a computer numerical controlled punching process. Further details of routine 1310 will be discussed below with respect to FIG. 14.

In routine 1315, an insert carrier plate 210 can be formed. The carrier plate 210 can comprise apertures 212 that are designed to align with the projections 300 of the dimple plate 210. Further details of routine 1315 will be discussed below with respect to FIG. 15.

Next, in routine 1320, cup-shaping inserts 215 can be made from an aluminum material. Specifically, the cup-shaping inserts 215 can be cut and machined from aluminum. Further details of routine 1320 will be discussed below with respect to FIG. 16.

Subsequently, in routine 1325, the frame 230 corresponding to the finished mat edge 1205 can be made with an extrusion process. Further details of routine 1325 will be discussed below with respect to FIG. 17.

In routine 1330, a material flow enhancing sheet 220 can be prepared. Specifically apertures 222 can be made within the material flowing enhancing sheet 220. Further details of routine 1330 will be discussed below with respect to FIG. 18.

Next, in routine 1335, various parts of the mold system 100 are assembled together to form a mold for making the finished mat 1200. Further details of routine 1335 will be discussed below with respect to FIG. 19.

In routine 1340, the raw material 225 can be made with a predefined geometry. Further details of 1340 will be discussed below with respect to FIG. 20.

In step 1345, the raw material 225 can be positioned within the mold system 100. Next, in step 1350, the mold system 100 supporting the raw material 225 can be placed in a press.

In step 1355, heat and pressure can be applied to a first side of the mold system 100 supporting the raw material 225. In step 1360, heat and pressure can be applied to a second side of the mold system 100 that does not have the raw material 225.

In routine 1365, the raw material can be moved in the geometries present in the mold system while the raw material 225 is in a fluidic state in order to form the finished mat 1200. Further details of routine 1365 will be discussed below with respect to FIG. 21.

In step 1370, the mold system 100/and cured raw material 225 can be removed from the heat and pressure that was applied previously in steps 1355 and 1360. In step 1375, the finished mat 1200 can be removed from the mold system 100.

Referring now to FIG. 14, this figure illustrates an exemplary flowchart of steps for an exemplary sub-method 1310 for forming a dimple plate 205 according to one exemplary embodiment of the present invention. Step 1405 is the first step in the sub-method in which a sheet of aluminum material is cut to a predetermined length and width. Specifically, the length and width generally corresponds to an interior region of the finished mat 1200 that will include the suction cups 1210 excluding the edged portion 1205.

Next, in step 1410 the sheet of aluminum material is punched at predetermined positions to form a two-dimensional array of convex surfaces 405 that project above the planar surfaces 305 and that correspond with the aperture 212 of the carrier plate 210. Each projection or indentation 300 is designed to have a similar or predefined geometry to facilitate mating with the cup-shaping inserts 215 and for forming an interior portion 1220 of the suction cups 1215. After step 1410, the process returns to routine 1315 of FIG. 13.

Referring now to FIG. 15, this figure illustrates a flow chart of steps of an exemplary sub-method 1315 for forming the carrier plate 210 according to one exemplary embodiment of the present invention. Step 1505 is the first step in the exemplary sub-method 1315 in which a sheet of aluminum material is cut to a predetermined length and width. The predetermined length and width of the material generally corresponds to the length and width of the dimple plate 205.

Both the carrier plate 210 and the dimple plate 205 have a predetermined length and width that generally corresponds to an interior region of the finished mat 1200 that comprises the suction cups 1210. The predetermined length and width of the dimple plate 205 and carrier plate 210 usually does not include the angled edge region 1205 of the finished mat 1200. Next, in step 1510, the aluminum sheet is machined to form a two dimensional array of apertures 212 that correspond with the indentations or projections 300 of the dimple plate 205. The process then returns to routine 1320, of FIG. 13

Referring now to FIG. 16, this figure illustrates a flow chart of steps of an exemplary sub-method 1320 for fabricating the cup-shaping inserts 215 according to one exemplary embodiment of the present invention. Step 1603 is the first step in the sub-method 1320 in which the apertures 610 are formed in the inserts 215. Next, in step 1605, the geometry 505, 510 for mating with a respective aperture 212 of the carrier plate 210 is formed on a first side of the insert 215. Next, in step 1610, a concave-shaped recess 605 is formed for mating with a respective convex-shaped surface 405 of the dimpled plate 205, for forming an exterior portion 1215 of a suction cup 1210.

Referring now to FIG. 16, this figure illustrates an exemplary sub-method 1325 for forming the frame 230 that corresponds to the mat edge 1205 of the finished mat 1200. Routine 1325 begins with step 1705 in which a die geometry for forming a predetermined angle surface is made. In step 1710, the metal is extruded with this die (not shown) such that it has a predetermined angled surface in order to form the frame 230 of the present invention. The process then returns to routine 1330 of FIG. 13.

Referring now to FIG. 18, this figure illustrates a flow chart of steps of an exemplary sub-method 1330 for preparing a material flow enhancing sheet 220 according to one exemplary embodiment of the present invention. Step 1805 is the first step in routine 1330 in which a size for the aperture punching devices is selected for a dye of a roller dye machine. Next, in step 1810, a predetermined spacing between the aperture punching devices of the roller dye is set.

In step 1815, the material flowing enhancing sheet 220 is fed through the roller dye. In step 1820, apertures 222 are punched in the material flow enhancing sheet 220 with the roller dye. In step 1825, the material flow enhancing sheet 220 is cut to a predetermined length corresponding to the length of the carrier plate 210 and dimple plate 205. The process then returns to routine 1335 of FIG. 13.

Referring now to FIG. 19, this figure illustrates a flow chart of steps of an exemplary sub-method 1335 for assembling parts to form the mold system 100 according to one exemplary embodiment of the present invention. Step 1905 is the first step of routine 1335 in which the dimple plate 205 is positioned on a surface of the spacer plate 217 that is adjacent to the base plate 105.

In step 1910, the dimple plate 205 is positioned and secured to the surface of the spacer plate 217. The dimple plate 205 can be secured to the base plate 105 and spacer plate 217 with fasteners such a combination of steel inserts pressed into the aluminum base plate 105 with flat head screws inserted through the carrier plate 210 and screwed into the inserts (that are different from the cup-shaped inserts 215). These same fasteners can be used to secure the base plate 205, the dimple plate 205 and the carrier plates 210 together. According to one exemplary embodiment, seventy-two inserts and screws were used for a three foot by ten foot' mold system.

In step 1915, the inserts 215 are positioned on the projections 300 of the dimple plate 205. Next, in step 1920, the carrier plate 210 is aligned over the inserts 215 and the dimpled plate 205.

In step 1925, the inserts 215 are secured to the dimpled plate 205 by mating the inserts with the apertures of the carrier plate 210. In other words, the carrier plate 210 can rest on the inserts 215, which in turn, also rest on the dimple plate 205.

In step 1930, the frame members 230 can be secured around the perimeter of the stacked sheets and plates. In step 1935, the apertures 222 of the material flowing enhancing sheet can be aligned with the apertures 212 of the carrier plate 210 as well as with the apertures 610 of the inserts 215.

In step 1940, the material flowing enhancing sheet 220 can be secured to the carrier plate 210 and the frame 230 such that the entire carrier plate 210 and a majority of the frame 230 are substantially covered by the material flowing enhancing sheet 220. The process then returns to routine 1340 of FIG. 13.

Referring now to FIG. 20, this figure illustrates a flow chart of steps of an exemplary sub-method 1340 for forming a raw material sheet 225 with a predefined geometry according to one exemplary embodiment of the present invention. Step 2005 is the first step of routine 1340 in which a dye having a predetermined cross sectional geometry is prepared. The dye can comprise a geometry for forming the thickened projections 227 of the raw material 225.

Next, in step 2010, the raw material 225 can be extruded to form the raw material sheet 225 having excess material or thickened regions 227 corresponding to the rows of apertures 212, 610 of the sheets, plates, and inserts 215 of the mold system 100. The process then returns to step 1345 of FIG. 13.

Referring now to FIG. 21, this figure illustrates a flow chart of steps of an exemplary sub-method 1365 for moving raw material into the geometries of the mold system 100 according to one exemplary embodiment of the present invention. Step 2105 is the first step of routine 1365 in which the additional raw material comprising the projections 227 and base raw material present between the projections 227 is moved into the interior of chamber 802 formed by the concave recess 605 of the insert 215 and the external surface 405 of the convex projection 300 of the dimple plate 205. The chamber 802 can form the suction cup 1210.

In step 2110, the raw material 225 is moved across the flow enhancing sheet 220 covering the frame 230 in order to form the angled edge 1205 of the finished mat 1200. The process then returns to step 1370 of the FIG. 13.

In summary, the disclosed method and system provide for making slip resistant mats that can withstand heavy mechanical loads and that do not move when traversed by such loads. The mold system and method also provide for making slip resistant mats in an efficient manner. The mold system and method also provide for a way to manufacture slip resistant mats that are lightweight and that can be made with a reduced amount of materials compared to conventional manufacturing techniques.

It should be understood that the foregoing relates only to illustrative embodiments of the present invention, and that numerous changes may be made therein without departing from the spirit and scope of the invention as defined by the following claims.

What is claimed is:

1. A method for making a mat comprising the steps of:
aligning apertures and cup-shaped recesses supported by a carrier plate with projections on a dimple plate
placing the carrier plate adjacent to the dimple sheet to form a mold;
positioning raw material on the mold;
moving the raw material into geometries of the mold to form the mat; and
removing the mat from mold.

2. The method of claim 1, further comprising positioning inserts comprising the cup-shaped recesses in the apertures of the carrier plate.

3. The method of claim 1, further comprising positioning the inserts comprising the cup-shaped recesses on projections of the dimple plate.

4. The method of claim 1, further comprising forming the dimple plate.

5. The method of claim 4, wherein forming a dimple plate comprises punching a metal sheet at predetermined positions to form the projections.

6. The method of claim 5, wherein punching the metal sheet comprises punching the metal sheet with a computer numerical controlled machine.

7. The method of claim 4, wherein forming the dimple plate comprises making the projections at predetermined positions to correspond with predetermined locations on a carrier plate.

8. The method of claim 4, wherein forming the dimple plate comprises making indentations at predetermined positions that provide for interior shapes of cups to be formed with the raw material.

9. The method of claim 1, further comprising forming a plurality of cup shaping inserts.

10. The method of claim 9, wherein forming a plurality of cup shaping inserts comprises, for each insert, forming a geometry for mating with a respective aperture in a carrier sheet.

11. The method of claim 9, wherein forming a plurality of cup shaping inserts comprises, for each insert, forming a concave recess for mating with the projections on the dimple sheet.

12. The method of claim 9, wherein forming a plurality of cup shaping inserts comprises, for each insert, forming a geometry that provides a shape for an exterior portion of a cup to be formed with the raw material.

13. The method of claim 1, further comprising forming a base plate.

14. The method of claim 1, further comprising forming the insert carrier plate.

15. The method of claim 1, further comprising forming a frame corresponding to a shape of an edge for the mat.

16. The method of claim 15, wherein forming a frame further comprises forming a frame with a predetermined angle for forming the edge of the mat having the predetermined angle.

17. The method of claim 1, further comprising forming a material flow enhancing sheet.

18. The method of claim 1, further comprising shaping the raw material with a predefined geometry.

19. The method of claim 1, further comprising placing the mold with raw material in a press.

20. The method of claim 1, further comprising applying heat and pressure to the mold supporting the raw material.

21. The method of claim 20, further comprising removing the mold and formed mat from heat and pressure.

22. A mold system comprising:
a dimple plate comprising a plurality of projections; and
a carrier plate comprising apertures and supporting cup-shaped recesses that mate with the projections of the dimple plate.

23. The mold system of claim 22, further comprising a plurality of inserts that comprise the cup-shaped recesses.

24. The mold system of claim 22, wherein each projections of the dimple plate comprises a shape corresponding to an interior portion of a suction cup.

25. The mold system of claim 22, wherein the projections each comprise a convex, curved surface relative to a planar portion of the dimple plate.

26. The mold system of claim 22, wherein each insert comprises a concave recess that has a shape corresponding to an exterior portion of a cup.

27. The mold system of claim 22, wherein each insert comprises an aperture and a concave recess leading to the aperture.

28. The mold system of claim 22, wherein each insert has a shape corresponding with a shape of each projection in order to form a cup structure when raw material is deposited between each respective insert and projection.

29. A mold system comprising:
a first plate with projections that comprise a geometry corresponding to an interior region of a suction cup;
a second plate comprising a plurality of apertures corresponding to the projections; and
cup shaping inserts that mate with the apertures and the projections.

30. The mold system of claim 29, wherein the projections comprise convex surfaces relative to a planar surface of the first plate.

31. The mold system of claim 29, wherein each cup shaping insert comprises a recess that comprises a geometry corresponding to an exterior region of a suction cup.

32. The mold system of claim 29, wherein each cup shaping insert comprises a concave surface.

33. The mold system of claim 29, further comprising a material flow enhancing sheet that further comprises a plurality of apertures corresponding with apertures of the second plate.

34. A mold system comprising:
a carrier plate having a plurality of apertures;
a plurality of inserts positioned in the apertures;
a dimple plate having a plurality of projections that mate with the plurality of inserts.

35. The mold system of claim 34, further comprising a frame for enclosing the carrier plate and dimple plate.

36. The mold system of claim 35, wherein the frame comprises a predetermined angled surface.

37. The mold system of claim 34, further comprising a base plate.

38. The mold system of claim 34, further comprising a material flow enhancing sheet.
